(19) United States
(12) Patent Application Publication
(10) Pub. No.: US 2011/0126015 A1
(43) Pub. Date: May 26, 2011

(54) SINK AUTHENTICATION SYSTEM AND METHOD USING MOBILE COMMUNICATION NETWORK

(75) Inventors: Tae-Shik SHON, Suwon-si (KR); Yong-Suk Park, Seoul (KR); Kyu-Suk Han, Yuseong-gu (KR); Kwang-Jo Kim, Yuseong-gu (KR); Jang-Seong Kim, Yuseong-gu (KR)

(73) Assignees: Samsung Electronics Co., Ltd., Suwon-si (KR); Korea Advanced Institute of Science and Technology (KAIST), Daejeon (KR)

(21) Appl. No.: 12/954,279

(22) Filed: Nov. 24, 2010

(30) Foreign Application Priority Data
Nov. 25, 2009 (KR) 10-2009-0114725

(51) Int. Cl. H04K 1/00; H04L 9/00

(52) U.S. Cl. 713/171; 380/270

(57) ABSTRACT

A system is provided for authentication between a mobile device (MD) and a sink using a mobile communication network. If a sink authentication request for the sink is received from the MD, a base station (BS) sends a sink authentication response including sink authentication information for the sink, to the MD. The MD forwards the sink authentication request for the sink to the BS, and if a sink authentication response is received from the BS, authenticates the sink using the received sink authentication information. The sink performs authentication with the MD.

### PRIORITY

This application claims priority under 35 U.S.C. §119(a) to a Korean Patent Application filed in the Korean Intellectual Property Office on Nov. 25, 2009 and assigned Serial No. 10-2009-0114725, the entire disclosure of which is incorporated herein by reference.

### BACKGROUND OF THE INVENTION

1. Field of the Invention

The present invention relates generally to a sink authentication system and method, and more particularly, to a system and method for authentication with a sink using a mobile communication network.

2. Description of the Related Art

In a common sensor network, if a node requests a connection to a sink connected to the sensor network, the sink transmits information about the node to other connected sinks, and the transmitted information is forwarded up to a base station (BS) through the connected sinks. Upon receipt of the node information, the BS performs node authentication and transmits authentication information back to the sink. Upon receiving the authentication information of the node, the sink determines whether the node has been authenticated, and performs authentication with the node.

In such a sensor network, there are various methods for authentication between a node and a sink. Mutual authentication in the sensor network is performed using various methods, including a method of authenticating a device newly participating in the sensor network and generating a link key with the authenticated node, and a method of allowing a BS to control sensor authentication to reduce the computational load on the sensors.

Thus, conventionally, to perform mutual authentication between a node and a sink, node information is transmitted to a BS and, in response, authentication information is received from the BS.

However, whenever the node accesses the sink, the node sends a node authentication request to the BS. Therefore, in multi-hop environments, it is problematic that node information should be transmitted to the BS and authentication information should be received from the BS, through a plurality of sinks.

Further, when authentication is performed by means of a BS in a multi-hop sensor network, the authentication must be performed through a large number of sinks, causing significant communication overhead, and an increase in the number of hops may undesirably lead to an exponential increase in sink detection time and communication overhead.

Additionally, if the node is mobile, in order to perform authentication between the moving node and a sink in a multi-hop sensor network, there is an increasing need to perform authentication between the moving node and the sink, using a mobile communication network.

### SUMMARY OF THE INVENTION

An aspect of the present invention is to address at least the above-mentioned problems and/or disadvantages and to provide at least the advantages described below. Accordingly, an aspect of the present invention is to provide a system and method for performing, with use of a mobile communication network, authentication between a mobile device and a sink using an authentication key which has been generated in advance through authentication between the mobile device and a mobile communication network server.

In accordance with one aspect of the present invention, there is provided a system for authentication between a mobile device (MD) and a sink using a mobile communication network. The system includes a base station (BS) for sending, if a sink authentication request for the sink is received from the MD, a sink authentication response including sink authentication information for the sink, to the MD; the MD for forwarding the sink authentication request for the sink to the BS, and if a sink authentication response is received from the BS, authenticating the sink using the received sink authentication information; and the sink for performing authentication with the MD.

In accordance with another aspect of the present invention, there is provided a method for authentication between a mobile device (MD) and a sink using a mobile communication network in an authentication system including the MD, the sink, a base station (BS), and a mobile communication network (MCN) server. The method includes sending, by the MD, a sink authentication request for the sink to the BS; sending, by the BS, a sink authentication response to the sink authentication request, to the MD; and receiving, by the MD, the sink authentication response and performing authentication with the sink.

In accordance with a further another aspect of the present invention, there is provided a method for performing authentication with a sink by a mobile device (MD) using a mobile communication network. The method includes, upon a request for authenticating the sink, sending a sink authentication request for the sink to a base station (BS); and upon receiving a sink authentication response for the sink from the BS, performing authentication with the sink.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a diagram showing a configuration of a system for performing mutual authentication between a mobile device (MD) and a sink according to an embodiment of the present invention;

FIG. 2 is a block diagram showing a structure of an MD according to an embodiment of the present invention;

FIG. 3 is a flowchart showing a process of performing authentication with a sink in an MD according to an embodiment of the present invention;

FIG. 4 is a flow diagram showing a process of performing authentication between an MD and a sink in an authentication system according to an embodiment of the present invention;

FIGS. 5A and 5B are block diagrams showing shared keys generated in an MD and a sink, respectively, according to an embodiment of the present invention; and

FIG. 6 is a diagram showing keys generated through authentication of an MD and a sink according to an embodiment of the present invention.

Throughout the drawings, the same drawing reference numerals will be understood to refer to the same elements, features and structures.

### DETAILED DESCRIPTION OF EMBODIMENTS OF THE PRESENT INVENTION

Embodiments of the present invention will now be described in detail with reference to the accompanying drawings. In the following description, specific details such as detailed configuration and components are merely provided to assist the overall understanding of embodiments of the present invention. In addition, descriptions of well-known functions and constructions are omitted for clarity and conciseness.

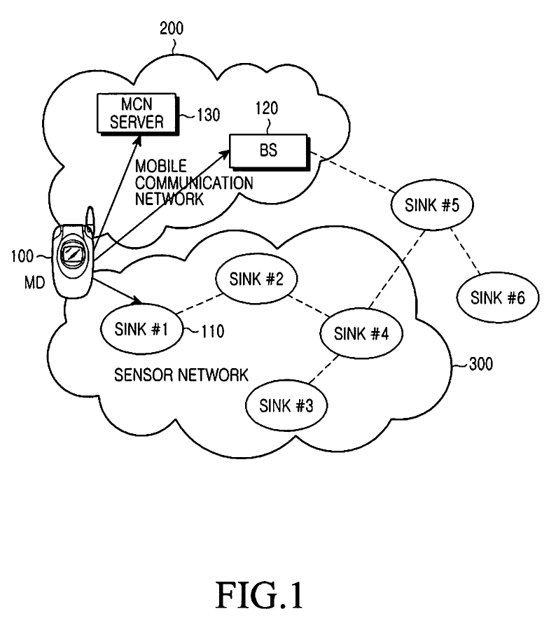

FIG. 1 shows a configuration of a system for performing mutual authentication between a mobile device and a sink according to an embodiment of the present invention.

The system of the present invention includes a mobile device (MD) 100, a plurality of sinks including a first sink 110, a base station (BS) 120, a mobile communication network (MCN) server 130, a mobile communication network 200, and a sensor network 300.

If an identifier (ID) of the first sink 110 is received from the first sink 110 along with a HELLO message, the MD 100 checks the ID of the first sink 110 and determines whether the first sink 110 has previously been authenticated.

If the first sink 110 is an authenticated sink, the MD 100 performs mutual authentication using a shared key generated by means of the first sink 110. If the first sink 110 is an unauthenticated sink, the MD 100 sends a sink authentication request message, requesting authentication of the first sink 110 to the BS 120 over the mobile communication network 200.

If a sink authentication response message with sink authentication information of the first sink 110 is received from the BS 120, the MD 100 generates a shared key using the received sink authentication information.

After that, the MD 100 sends the first sink 110 a sink authentication request including shared key generation information for shared key generation. Upon request for shared key check from the first sink 110, the MD 100 checks generated shared keys.

For searching the surrounding environment, the first sink 110 periodically broadcasts its own ID along with a HELLO message. In response, if a sink authentication request with shared key generation information is received from the MD 100, the first sink 110 generates a shared key using the received shared key generation information and then requests the MD 100 to check the shared key.

The BS 120 is connected to a plurality of sinks, and stores authentication information of the connected sinks. Upon receiving a sink authentication request message from the MD 100, the BS 120 determines whether the MD 100 that transmitted the sink authentication request message is an MD that has already been authenticated with the BS 120 itself, and, if so, the BS 120 transmits sink authentication information for authentication of the first sink 110 to the MD 100.

If the MD 100 is an unauthenticated MD, the BS 120 requests the MCN server 130 to authenticate the MD 100. Authenticating the MD 100 is the same as the process of authenticating an MD in common mobile communication.

If an authentication response for the MD 100 is received from the MCN server 130, the BS 120 transmits sink authentication information for authentication of the first sink 110, to the MD 100.

If an authentication request for the MD 100 is received from the BS 120, the MCN server 130 sends the BS 120 an MD authentication response message including the requested authentication information of the MD 100.

The mobile communication network 200 is a communication network between the MD 100, the BS 120 and the MCN server 130. The MD 100 generates a mutual shared key through a Generic Bootstrapping Architecture (GBA) bootstrapping process with the MCN server 130, and performs mutual authentication using the generated shared key. The GBA bootstrapping process generates a shared key between the MD 100 and the MCN server 130 using a seed key of a user ID card 40 mounted in the MD 100.

The sensor network 300 is a communication network between the MD 100, the BS 120 and a plurality of sinks.

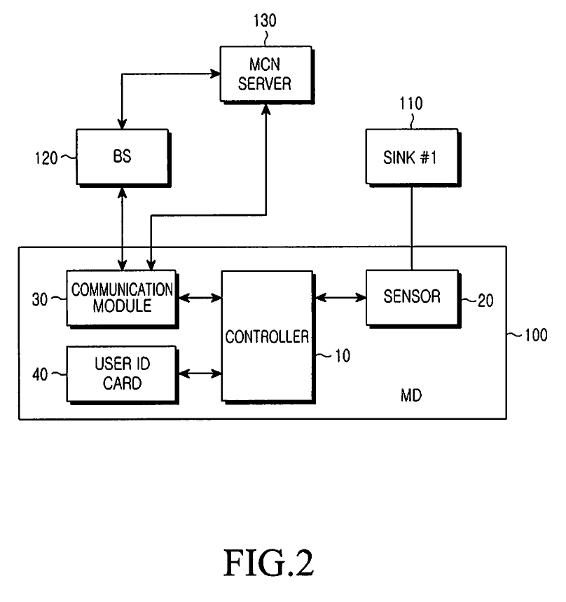

FIG. 2 shows a structure of an MD according to an embodiment of the present invention.

The MD 100 according to an embodiment of the present invention includes a controller 10, a sensor 20, a communication module 30, and the user ID card 40.

The controller 10 determines if the first sink 110 has already been authenticated, using ID information of the first sink 110 along with a HELLO message received from the first sink 110. If the first sink 110 has already been authenticated, the controller 10 performs mutual authentication with the first sink 110 using a shared key, which has already been generated by means of the sensor 20.

If the first sink 110 is an unauthenticated sink, the controller 10 sends an authentication request for the first sink 110 to the BS 120 through the communication module 30.

If a sink authentication response with sink authentication information of the first sink 110 is received from the BS 120 via the communication module 30, the controller 10 generates a shared key using the received sink authentication information. The controller 10 stores the generated shared key in a memory of the MD 100.

Thereafter, the controller 10 sends a sink authentication request with shared key generation information to the first sink 110 through the sensor 20.

If a response to the sink authentication request is received from the first sink 110, the controller 10 sends a request to check the generated shared key, to the first sink 110 through the sensor 20.

The sensor 20 receives ID information of the first sink 110 from the first sink 110 along with a HELLO message, provides it to the controller 10, and transmits shared key generation information for generation of a shared key to the first sink 110.

The communication module 30 receives ID information of the first sink 110 along with the HELLO message received from the first sink 110, and sends the BS 120 a sink authentication request message for requesting authentication of the first sink 110. The communication module 30 receives a sink authentication response message with sink authentication information of the first sink 110, from the BS 120.

The user ID card 40 stores a shared key generated through a GBA authentication process between the MD 100 and the MCN server 130. The user ID card 40 generates a shared key by performing GBA authentication with the MCN server 130 using its own seed key, and stores the generated shared key in the memory of the MD 100.

As described above, the present invention performs authentication between an MD and a sink using sink authentication information received from a BS over a mobile communication network, thereby reducing the time required for initial authentication between the MD and the sink.

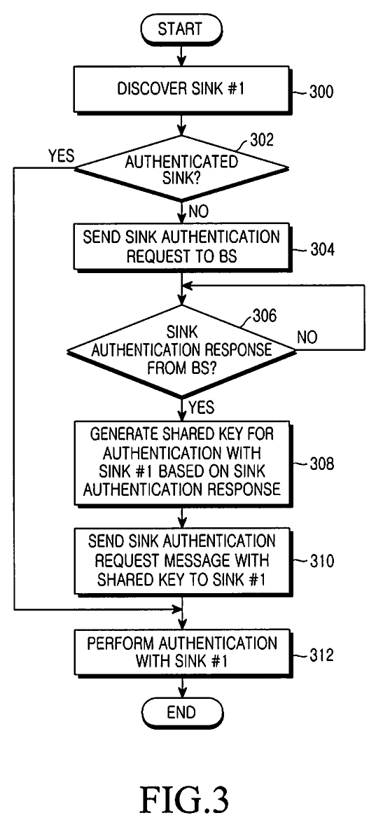

FIG. 3 shows a process of performing authentication with a sink in an MD according to an embodiment of the present invention.

In step 300, the controller 10 discovers a first sink 110 by receiving an ID of the first sink 110 along with a HELLO message from the first sink 110 via the sensor 20.

In step 302, the controller 10 determines whether the discovered first sink 110 has previously been authenticated. If it has been authenticated, the controller 10 proceeds to step 312. Otherwise, the controller 10 sends an authentication request for the first sink 110 to the BS 120 in step 304. In response, the BS 120 sends an authentication request for the MD 100 that made the authentication request, to the MCN server 130, and if the MD 100 is authenticated by the MCN server 130, the BS 120 sends the MD 100 a sink authentication response including sink authentication information for the first sink 110.

If a sink authentication response is received from the BS 120 via the communication module 30 in step 306, the controller 10 generates a shared key using the sink authentication information received with the sink authentication response in step 308.

In step 310, the controller 10 transmits shared key generation information including the generated shared key, to the first sink 110 via the sensor 20.

Proceeding to step 312 from steps 302 and 310, the controller 10 performs an authentication operation with the first sink 110, proceeds with checking the generated shared key, and then ends the authentication process.

This authentication process can facilitate fast initial authentication between an MD and a sink.

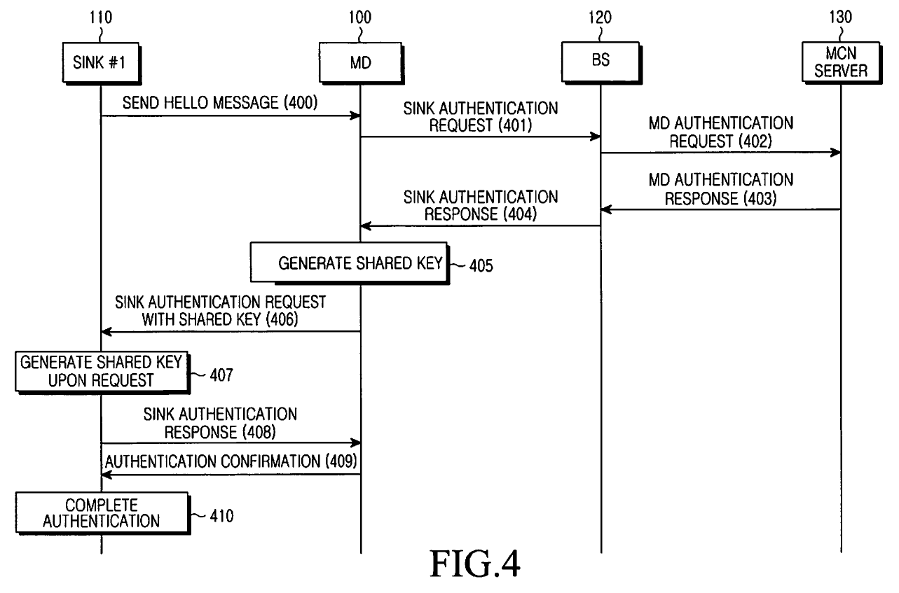

FIG. 4 shows a process of performing authentication between an MD and a sink in an authentication system according to an embodiment of the present invention.

It is assumed in an embodiment of the present invention that the MD 100 has not yet been authenticated with the MCN server 130 and the first sink 110 has not yet been authenticated with the MD 100.

In step 400, the first sink 110 periodically broadcasts related information along with a HELLO message.

Specifically, the first sink 110 generates, along with a HELLO message, a random number RAND and a time stamp TS indicating a generation time of the HELLO message, and generates authentication information u[0]=enc{CK_S1, RAND∥TS} indicating that the generated HELLO message, TS and RAND are possessed by a first sink S1. Here, u[0] is information obtained by encrypting TS and RAND with an encryption key CK_S1 shared between the BS 120 and the first sink 110. The first sink 110 generates integrity information v[0]=MAC|{IK_S1, S1∥u[0]} for checking integrity of the generated u[0], where IK_S1 represents an integrity check key shared between the BS 120 and the first sink 110. MAC is the Message Authentication Code.

Thereafter, the first sink 110 broadcasts S1 (ID of the first sink), u[0] and v[0] along with the generated HELLO message.

The MD 100, which has received the related information along with the HELLO message, determines if the first sink 110 has previously been authenticated with the MD 100, by checking the received ID information of the first sink 110. If the first sink 110 has previously been authenticated, the MD 100 performs mutual authentication using the shared key that was generated during authentication.

If the first sink 110 is an unauthenticated sink, the MD 100 sends a sink authentication request message for requesting authentication of the first sink to the BS 120 in step 401. Thereafter, the MD 100 generates authentication information u[1]=enc{CK_MD, S1∥u[0]∥v[0]} obtained by encrypting S1, u[0] and v[0] with an encryption key CK_MD shared between the BS 120 and the MD 100, and generates integrity information v[1]=MAC{IK_MD, MD∥BS∥S1∥APP_REQ∥u[1]} for checking integrity of u[1], where IK_MD represents an integrity check key shared between the BS 120 and the MD 100. The encryption key CK_MD and the integrity key IK_MD are generated by the GBA bootstrapping operation of the MCN server 130 and the MD 100, which is performed before step 410. The GBA bootstrapping operation refers to an operation of generating a shared key between the MD 100 and the MCN server 130 using the user ID card 40 and then performing mutual authentication.

Thereafter, the MD 100 transmits, to the BS 120, MD (ID of the MD 100), u[1] and v[1] along with the generated sink authentication request message, thereby requesting sink authentication.

Upon receipt of the request, the BS 120 checks the received ID of the MD 100 to determine if the MD 100, that has requested the sink authentication, has previously been authenticated. If the MD 100 is an unauthenticated MD, the BS 120 sends an authentication request for the MD 100 to the MCN server 130 in step 402.

In step 403, the MCN server 130 sends the BS 120 an MD authentication response message including an encryption key and an integrity key of the MD 100, which the MCN server 130 has shared in advance with the MD 100 through the GBA operation, such as set forth in 3GPP TS 33.220.

In step 404, the BS 120 generates a sink authentication response message including sink authentication information for authentication of the first sink 110 using the received encryption key and integrity key of the MD 100, and sends the generated message to the MD 100.

Specifically, the BS 120 generates, along with a sink authentication response message, authentication information u[2]=enc{CK_S1, RAND∥TS∥h(RAND∥CK_MD)∥h(RAND∥IK_MD)} obtained by encrypting a random number RAND, a time stamp TS, h(RAND∥CK_MD) and h(RAND∥IK_MD) with an encryption key CK_S1 the BS 120 is sharing with the first sink, where h(RAND∥CK_MD) is a value obtained by applying a hash function to an encryption key of the MD 100 and a random number, and h(RAND∥IK_MD) is a value obtained by applying a hash function to an integrity key of the MD 100 and a random number. The h(RAND∥CK_MD) and h(RAND∥IK_MD) are used to generate a shared key between the MD 100 and the first sink 110.

Additionally, the BS 120 generates integrity information v[2]=MAC{IK_S1, BS∥S1∥MD∥RAND∥u[2]} for checking integrity of u[2].

Thereafter, the BS 120 generates authentication information u[3]=enc{CK_MD, RAND∥TS∥h(RAND∥CK_S1)∥h(RAND∥IK_S1)∥u[2]∥v[2]} obtained by encrypting a random number RAND, a time stamp TS indicating a generation time of the authentication response message, h(RAND∥CK_S1), h(RAND∥IK_S1), u[2] and v[2], with CK_MD. Further, the BS 120 generates integrity information v[3]=MAC{IK_MD, BS∥MD∥S1∥APP_RES∥u[3]} for checking integrity of u[3], where APP_RES represents the authentication response message.

The BS 120 transmits, to the MD 100, MD (ID of the MD 100), u[3] and v[3] along with the generated sink authentication response message.

In step 405, the MD 100 generates a shared key for authentication with the first sink 120 according to the sink authentication response.

Specifically, the MD 100 checks the integrity of u[3] by checking the received v[3], decrypting the received u[3] using its encryption key, and then detecting a random number RAND, h(RAND∥CK_S1), h(RAND∥IK_S1), u[2] and v[2].

Thereafter, the MD 100 generates a sink authentication request message, and generates a shared key CK_S1_MD=KDF(h(RAND∥CK_S1), h(RAND∥CK_MD)) and an integrity key IK_S1_MD=KDF(h(RAND∥IK_S1), h(RAND∥IK_MD)), for authentication with the first sink 110 using the detected RAND, h(RAND∥CK_S1), h(RAND∥IK_S1) and its own encryption key. Additionally, the MD 100 generates integrity information v[4]=MAC{IK_S1_MD, AUTHREQ∥MD∥S1∥RAND∥u[2] ∥v[2]}, where v[4] is information confirming that u[2] and v[2] are information received from the MD 100.

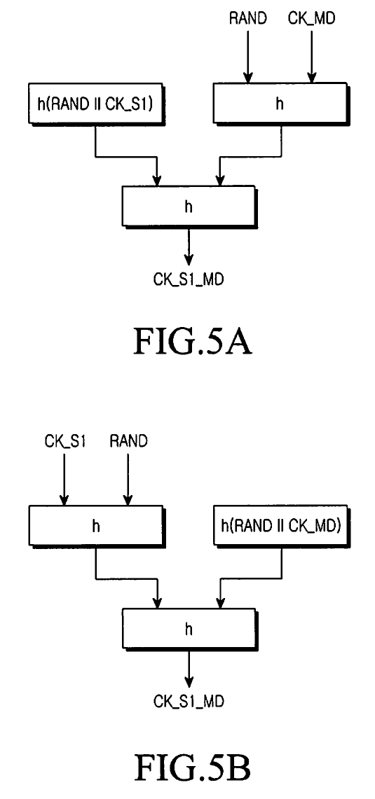

An operation of generating a shared key in the MD 100 will be described with reference to FIG. 5A. The MD 100 generates a shared key CK_S1_MD by applying a hash function to a random number RAND and its own encryption key CK_MD, and applying again a hash function to the hash-applied value and h(RAND∥CK_S1). Moreover, the MD 100 may generate an integrity key IK_S1_MD using h(RAND∥IK_S1), in the same manner.

Referring back to step 406, the MD 100 transmits, to the first sink 110, MD (its own ID), u[2], v[2] and v[4] along with the generated sink authentication request message AUTHREQ.

In step 407, the first sink 110 generates a shared key according to the received sink authentication request message.

Specifically, the first sink 110 performs an integrity check on u[2] by checking the received v[2], and calculating a random number RAND, a time stamp TS, h(RAND∥CK_MD) and h(RAND∥IK_MD), for shared key generation, by decrypting u[2]. Thereafter, the first sink 110 generates a shared key CK_S1_MD and an integrity key IK_S1_MD, for authentication with the MD 100, using the calculated RAND, h(RAND∥CK_MD) and h(RAND∥IK_MD), and then checks v[4], thereby determining that the information transmitted along with the presently transmitted sink authentication request message has been received from the MD 100. Valid periods of the generated shared key CK_S1_MD and integrity key IK_S1_MD are defined as a time stamp TS.

An operation of generating a shared key in the first sink 110 will be described with reference to FIG. 5B. The first sink 110 generates a shared key CK_S1_MD by applying a hash function to a random number RAND and its own encryption key CK_S1, and applying again a hash function to the hash-applied value and h(RAND∥CK_MD). Additionally, the first sink 110 may generate an integrity key IK_S1_MD using h(RAND∥IK_MD), in the same manner.

Referring back to step 408, the first sink 110 sends the MD 100 a sink authentication response to the sink authentication request.

Specifically, the first sink 110 generates a sink authentication response message, receives authentication information from the MD 100 within a random number-generated period, and generates information v[5]=MAC{IK_S1_MD, AUTHRES∥S1∥MD∥RAND} for indicating that it has generated a shared key using the received authentication information. Thereafter, the first sink 110 transmits, to the MD 100, S1 (its own ID), MD (ID of the MD 100), and v[5] along with the sink authentication response message AUTHRES.

In step 409, the MD 100 sends an authentication confirmation message to the first sink 110.

Specifically, the MD 100 checks the received v[5], and determines that the first sink 110 has generated a shared key using the authentication information the MD 100 transmitted. Thereafter, the MD 100 generates an authentication confirmation message AUTHCON, and generates information v[6]=MAC{IK_S1_MD, AUTHCON∥MD∥RAND+1} for indicating that an authentication operation has been performed within a random number-generated period by checking validity of a random number.

The MD 100 transmits, to the first sink 110, MD (its own ID), S1 (ID of the first sink 110) and v[6] along with the generated authentication confirmation message.

In step 410, the first sink 110 checks the received information and completes the authentication. To be specific, the first sink 110 checks the received v[6], and completes the authentication process with the MD 100 if the v[6] is valid.

While steps 408 to 410 have been described as part of the authentication process of FIG. 4, it is noted that these steps are optional.

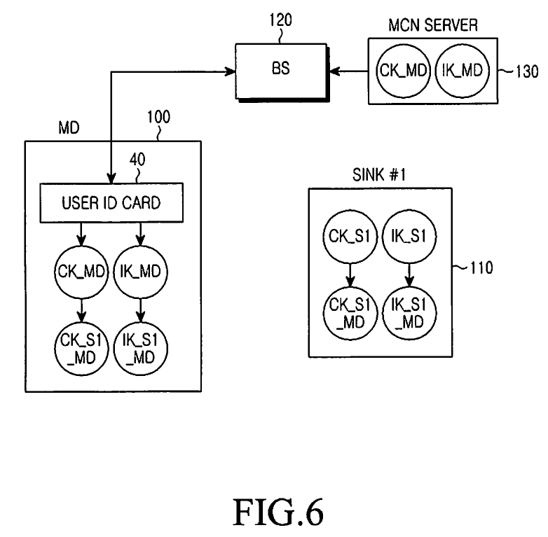

A process of generating a shared key between the MD 100 and the first sink 110 will be described with reference to FIG. 6. The MD 100 performs a GBA authentication process with the MCN server 130 using a seed key of the user ID card 40, and stores, in advance, an encryption key CK_MD and an integrity key IK_MD, which are generated through the GBA authentication process. The purpose of storing the encryption key and the integrity key generated through the GBA authentication process in advance is to minimize the role of the user ID card 40, to secure the seed key stored in the user ID card 40 even though the shared key is disclosed, and to facilitate the connection of the mobile communication network and the sensor network, compared with the existing network connection method.

Thereafter, when authenticating the first sink 110, the MD 100 performs authentication with the BS 120 using its own encryption key CK_MD and the integrity key IK_MD, and generates a shared key CK_S1_MD and an integrity key IK_S1_MD using the sink authentication information received through the BS 120.

The first sink 110 also generates a shared key CK_S1_MD and an integrity key IK_S1_MD using sink authentication information received from the MD 100 along with its own encryption key CK_MD and the encryption key IK_MD.

If the MD 100 wants to re-authenticate the first sink 110 and a connection between the MD 100 and the first sink 110 is made, the MD 100 checks authentication with the first sink 110 and then transmits authentication information for an adjacent sink to the first sink 110, allowing the first sink 110 to perform a re-authentication operation. If mutual authentication between the MD 100 and the first sink 110 is invalid, the MD 100 performs authentication with the first sink 110 by performing the foregoing authentication operation.

As apparent from the foregoing description, during mutual authentication between an MD and a sink, the present invention performs authentication between a BS and the MD over a mobile communication network, and performs authentication with the sink using sink authentication information received from the BS, thereby reducing communication and computational overhead for authentication and key exchange in a multi-hop environmental sensor network, and thus reducing the time required for authentication.

When performing authentication between an MD and a sink using a mobile communication network, the present invention receives sink authentication information from a BS over the mobile communication network without the need to receive authentication information from the BS using a multi-hop environmental sensor network, thereby reducing communication and computational overhead for authentication and key exchange in the multi-hop environmental sensor network, and thus reducing the time required for authentication.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A system for authentication between a mobile device (MD) and a sink using a mobile communication network, comprising:
a base station (BS) for sending, if a sink authentication request for the sink is received from the MD, a sink authentication response including sink authentication information for the sink, to the MD;
the MD for forwarding the sink authentication request for the sink to the BS, and if a sink authentication response is received from the BS, authenticating the sink using the received sink authentication information; and
the sink for performing authentication with the MD.

2. The system of claim 1, further comprising a mobile communication network (MCN) server for sending an authentication response upon an authentication request for the MD.

3. The system of claim 1, wherein upon a request for authenticating the sink, the MD determines whether the sink has previously been authenticated, and if the sink is an unauthenticated sink, sends a sink authentication request message for the sink to the BS.

4. The system of claim 2, wherein upon receiving a sink authentication request message from the MD, the BS determines whether the MD has previously been authenticated, and if the MD is an unauthenticated MD, sends an MD authentication request message for requesting authentication of the MD, to the MCN server.

5. The system of claim 4, wherein upon receiving an MD authentication request message from the BS, the MCN server generates an MD authentication response message including MD authentication information generated in advance through authentication with the MD, and sends the MD authentication response message to the BS.

6. The system of claim 5, wherein upon receiving the MD authentication response message from the MCN server, the BS authenticates the MD using the MD authentication information, generates a sink authentication response message including sink authentication information for the sink, and sends the sink authentication response message to the MD.

7. The system of claim 6, wherein upon receiving the sink authentication response message from the MCN server, the MD generates a shared key for authentication with the sink using the sink authentication information, and performs authentication with the sink using the generated shared key.

8. A method for authentication between a mobile device (MD) and a sink using a mobile communication network in an authentication system including the MD, the sink, a base station (BS), and a mobile communication network (MCN) server, comprising:
sending, by the MD, a sink authentication request for the sink to the BS;
sending, by the BS, a sink authentication response to the sink authentication request, to the MD; and
receiving, by the MD, the sink authentication response and performing authentication with the sink.

9. The method of claim 8, wherein sending a sink authentication request for the sink comprises:
upon a request for authenticating the sink, determining whether the sink has previously been authenticated; and
if the sink is an unauthenticated sink, sending a sink authentication request message for the sink to the BS.

10. The method of claim 9, wherein sending a sink authentication response to the sink authentication request comprises:
upon receiving a sink authentication request message from the MD, determining whether the MD has previously been authenticated;
if the MD is an unauthenticated MD, sending an MD authentication request message for requesting authentication of the MD, to the MCN server;
receiving, from the MCN server, an MD authentication response message including MD authentication information generated in advance through authentication with the MD;
authenticating the MD based on the received MD authentication information; and
generating a sink authentication response message including sink authentication information for the sink, and sending the sink authentication response message to the MD.

11. The method of claim 10, wherein receiving the sink authentication response and performing authentication with the sink comprises:
upon receiving the sink authentication response message from the MCN server, generating a shared key for authentication with the sink using the sink authentication information; and
performing authentication with the sink using the generated shared key.

12. A method for performing authentication with a sink by a mobile device (MD) using a mobile communication network, comprising:
upon a request for authenticating the sink, sending a sink authentication request for the sink to a base station (BS); and
upon receiving a sink authentication response for the sink from the BS, performing authentication with the sink.

13. The method of claim 12, wherein sending a sink authentication request for the sink comprises:
upon a request for authenticating the sink, determining whether the sink has previously been authenticated; and
if the sink is an unauthenticated sink, sending a sink authentication request message for the sink to the BS.

14. The method of claim 13, wherein performing authentication with the sink comprises:
upon receiving a sink authentication response message from the MCN server, generating a shared key for authentication with the sink using the sink authentication information; and
transmitting shared key generation information based on the generated shared key to the sink and performing authentication with the sink.
